(19) United States
(12) Patent Application Publication
(10) Pub. No.: US 2013/0028722 A1
(43) Pub. Date: Jan. 31, 2013

(54) System and Method for Improving Turbine Efficiency using a Frame and Shroud System

(71) Applicants: Michael Gregory Blackburn, Austin, TX (US); Steven Dwight Brown, Austin, TX (US)

(72) Inventors: Michael Gregory Blackburn, Austin, TX (US); Steven Dwight Brown, Austin, TX (US)

(21) Appl. No.: 13/194,903

(22) Filed: Jul. 29, 2011

(51) Int. Cl. F03D 3/04

(52) U.S. Cl. 415/208.1

(57) ABSTRACT

A system and method for improving turbine efficiency using a frame and shroud system is described herein. Specifically, a shroud system can comprise a frame comprising a base and a substantially vertical support structure, said substantially support structure having a top portion and a bottom portion, wherein said bottom portions connect to a base. In another embodiment, the shroud system can also comprise an upper wind shroud connected to said top portion of said support structure, wherein said upper wind shroud is angled between thirty degrees and seventy-five degrees, further wherein a front portion of said wind shroud extends higher than a rear portion of said wind shroud.

### BACKGROUND

This disclosure relates to a system and method for improving turbine efficiency using a frame and shroud system.

In recent years, demand for power has increased. However, most power generation methods have been inefficient, costly, and bad for the environment. To combat environmental issues, people have looked to clean forms of energy production, including solar and wind. Today, various methods exist for generating power using wind turbines. Typically, turbines were built using a vertical axis rotor shaft. However, often such system produces much less power because the wind turbines are typically located closer to the ground. Additionally, most proposed airborne wind turbine designs involve various types of reciprocating actions, requiring airfoil surfaces to backtrack against the wind for part of the cycle. Backtracking against the wind leads to inherently lower efficiency.

As such it would be useful to have an improved system and method for improving turbine efficiency using a frame and shroud system.

### SUMMARY

A system and method for improving turbine efficiency using a frame and shroud system is described herein.

In one embodiment, a shroud system can comprise a frame comprising a base and a substantially vertical support structure, said substantially support structure having a top portion and a bottom portion, wherein said bottom portions connect to a base. In another embodiment, the shroud system can also comprise an upper wind shroud connected to said top portion of said support structure, wherein said upper wind shroud is angled between thirty degrees and seventy-five degrees, further wherein a front portion of said wind shroud extends higher than a rear portion of said wind shroud.

Finally, in one embodiment, the shroud system can further comprise a frame comprising a base, and a lower wind shroud connected to said frame, wherein said lower wind shroud is substantially vertical.

### BRIEF DESCRIPTION OF THE DRAWINGS

FIG. 1 illustrates a wind turbine shroud system mounted on a flat roof at the edge of a structure on a prevailing wind edge.

FIG. 2 illustrates a shroud system.

FIG. 3 illustrates a turbine system mounted to a shroud system.

FIG. 4 illustrates wind shrouds.

FIG. 5A illustrates blade mounts on a blade set.

FIG. 5B illustrates blade mount curvature.

FIG. 6 illustrates a multiple blade set wind turbine shroud system.

### DETAILED DESCRIPTION

Described herein is a system and method for improving turbine efficiency using a frame and shroud system. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

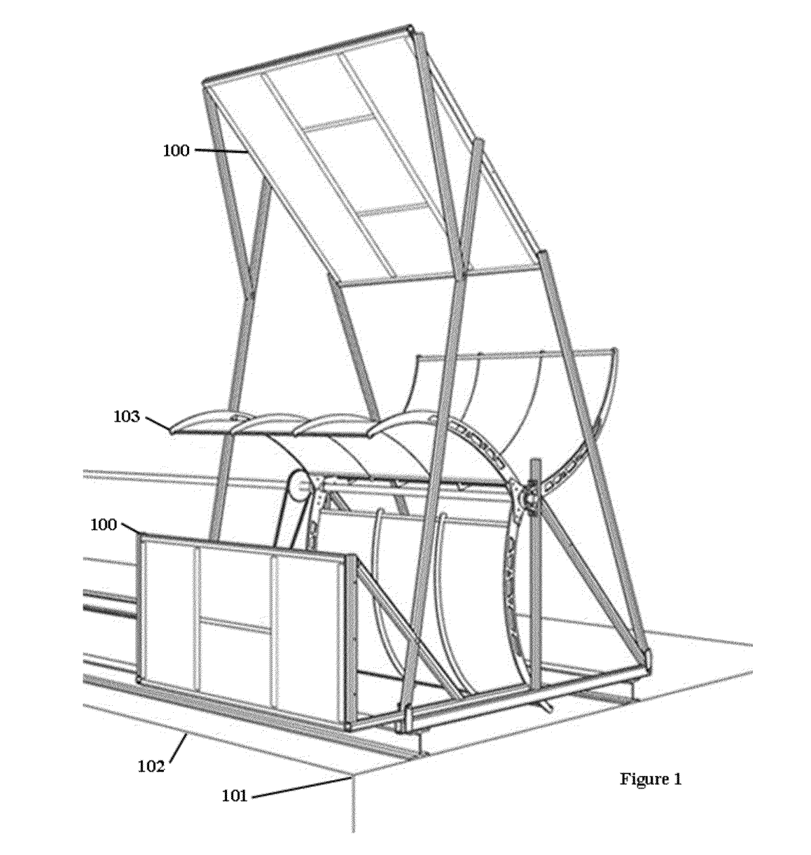

FIG. 1 illustrates a shroud system 100 mounted on a flat roof at the edge of a structure 101 on a prevailing wind edge 102. Structure 101 can include, but is not limited to, a building, oilrig, platform, or trailer. Shroud system 100 can support or otherwise mount around a turbine system 103, and can help direct wind toward or away from key points of turbine system 103. Such wind direction can help achieve more efficient electricity generation by turbine system 103.

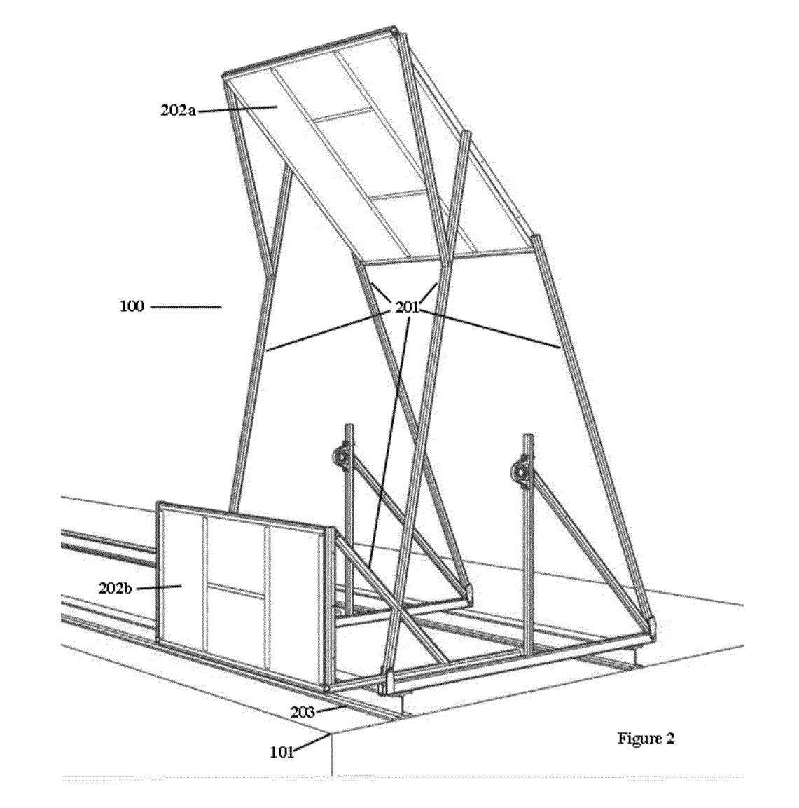

FIG. 2 illustrates shroud system 100. Shroud system 100 can comprise of a frame 201 and a one or more wind shrouds 202. In one embodiment, frame 201 can include a substantially vertical support structure having a top portion and a bottom portion, and a base 203 to connect shroud system 100 to structure 101. Base 203 can connect to a bottom portion of frame 201, or can be a portion of frame 201. In one embodiment, base 203 can include horizontal beams. In another embodiment, base can include fasteners to connect frame 201 to structure 101. Wind shrouds 202 can mount to frame 201. The shape of frame 202 can vary depending on the placement of shroud system 100, e.g., a building, oilrig, platform, etc., but in each configuration can support wind shroud 202 so that wind shroud 202 is positioned properly to direct wind. Shroud system 100 can be comprised of a hard weatherproof material. Wind shrouds 202 can comprise an upper wind shroud 202a and/or a lower wind shroud 202b. Frame 201 can also include a one or more surface mounts. Surface mounts enable shroud system 100 to stay affixed to structure 101 during high winds.

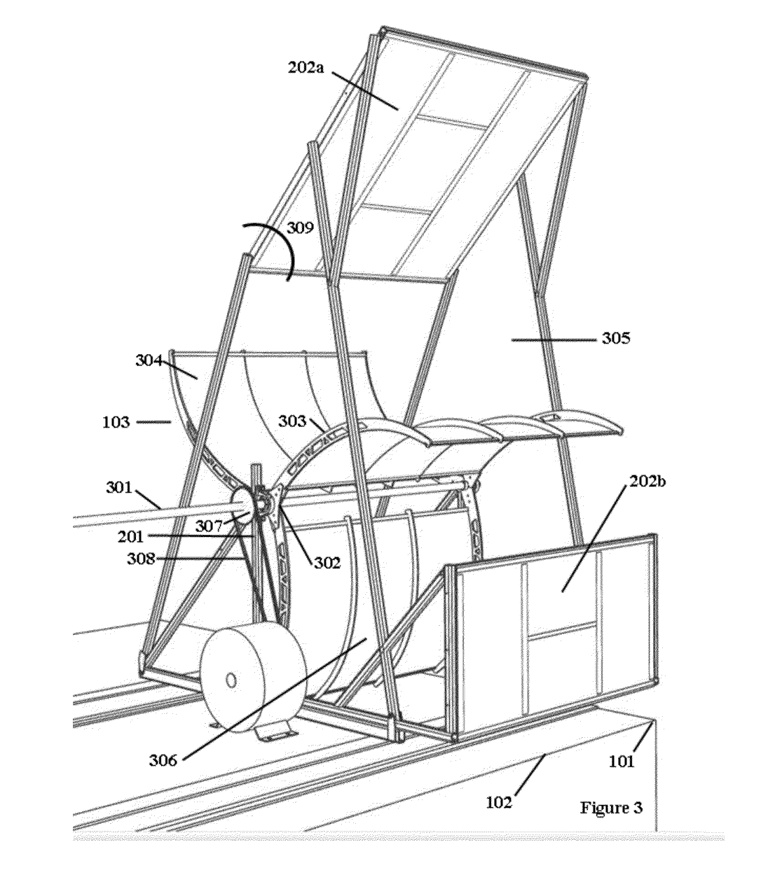

FIG. 3 illustrates a turbine system 103 mounted to shroud system 100. Turbine system 103 can comprise a shaft 301, a hub 302, a plurality of blade mounts 303, and/or a plurality of blades 304. As shown in FIG. 3, blades 304 can connect to hub 302 via blade mounts 303 around a shaft 301, referred to together as a blade set. Hub 302 can rotate around shaft 301, using bearings or any other rotary mechanism commonly known in the art. In one embodiment, turbine system 103 can connect to frame 201 using attachment methods such as, but not limited to, bearing mounts. In another embodiment, turbine system can mount to a separate turbine support structure. In such embodiment, shroud system would surround, and in some cases, attach to turbine support structure.

Turbine system 103 receives wind in an intake 305 and a blade return orifice 306. At intake 305, blade 304 can be curved. In a preferred embodiment, blade 304 is curved with edges tending toward intake 305, thereby “cupping” the wind as it enters intake 305. In one implementation wind shroud system 100 and turbine system 103 can be used in conjunction with each other, mounted on a prevailing wind edge 102 of structure 101. A one or more drive gears 307 can be mounted on shaft 301. A chain 308 or other similar device known in the art can connect drive gears to a generator. Thus as blades 304 move, shaft 301 rotates, causing generator to turn.

Lower wind shroud 202b can be connected to frame 201 in front of blade return area 306. In such configuration, lower wind shroud 202b can prevent prevailing winds from blowing against blade 304 as it returns. In one embodiment, lower wind shroud 202b can be placed vertically, as shown in FIG. 3. In another embodiment, wherein prevailing wind edge 102 rises above structure 101, prevailing wind edge 102 can replace lower wind shroud 202b. Another factor that can increase turbine system 103 efficiency is a differential pressure created when wind built up on prevailing wind edge 102 and lower shroud 202b, accelerates into a lower pressure above and behind lower shroud 202b. Such pressure differential can add additional uplift of air into intake 305.

Upper wind shroud 202a can connect to frame 201 above turbine system 103. Upper wind shroud 202a can be positioned with the face of upper shroud 202a fixed at an angle 309 to the oncoming wind. Such configuration can accelerate and direct the wind to blades 304 in their moment of downswing at intake 305. In one embodiment, angle 309 can be between thirty and seventy-five degrees, such that a front portion of upper wind shroud 202a extends higher than a rear portion of upper wind shroud 202a. In another embodiment, angle 309 can be 45 degrees.

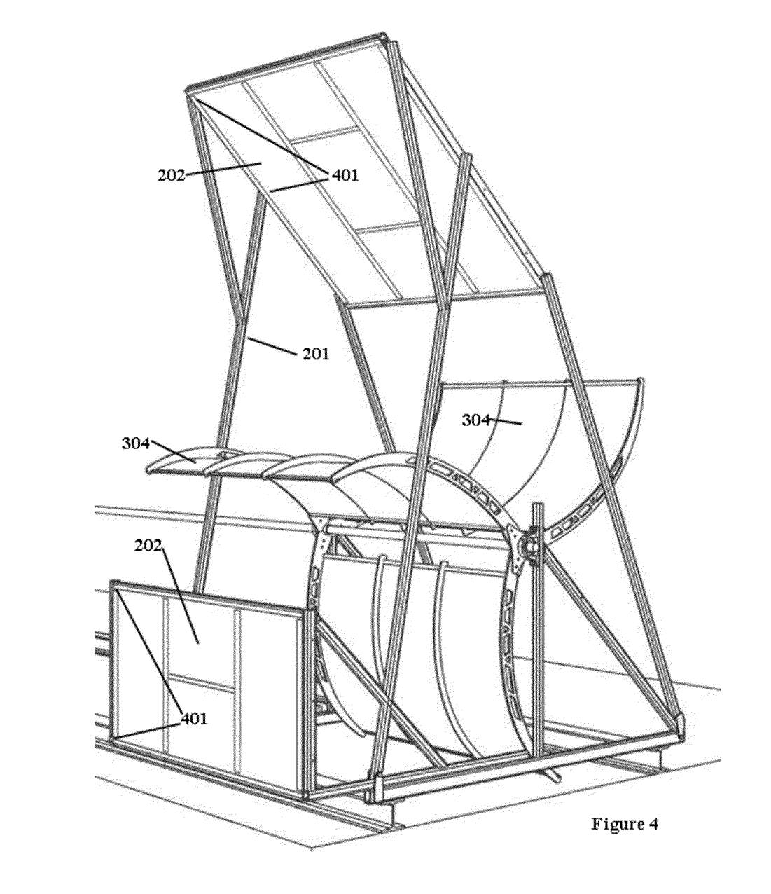

FIG. 4 illustrates wind shrouds 202. Winds shrouds 202 can connect to frame 201 at shroud mount portions 401 of frame 201. In one embodiment, shroud mounts can connect to wind shroud 202 on opposite ends of wind shroud 202. One or more support bars can go across wind shroud 202 horizontally and/or vertically for structure support. The use of wind shrouds can diminish turbulence, produce or enhance a beneficial vortex effect, and significantly increase the amount of wind entering blades 304, thus significantly increasing electrical power generation.

Wind shrouds 202 can be comprised of 6061 T-6 aluminum or any other material suitable in the art. Using 6061 T-6 aluminum can increase longevity and function of shroud system 100. Coastal areas have much wind but are often harsh environments. The 6061 T-6 and 7075 have an appropriate strength-to-weight ratio and are also resistant to corrosion. Additionally, this aluminum retains its shape, strength, and smooth surfaces. Such material can offer efficient, smooth, and noise-free operation over time.

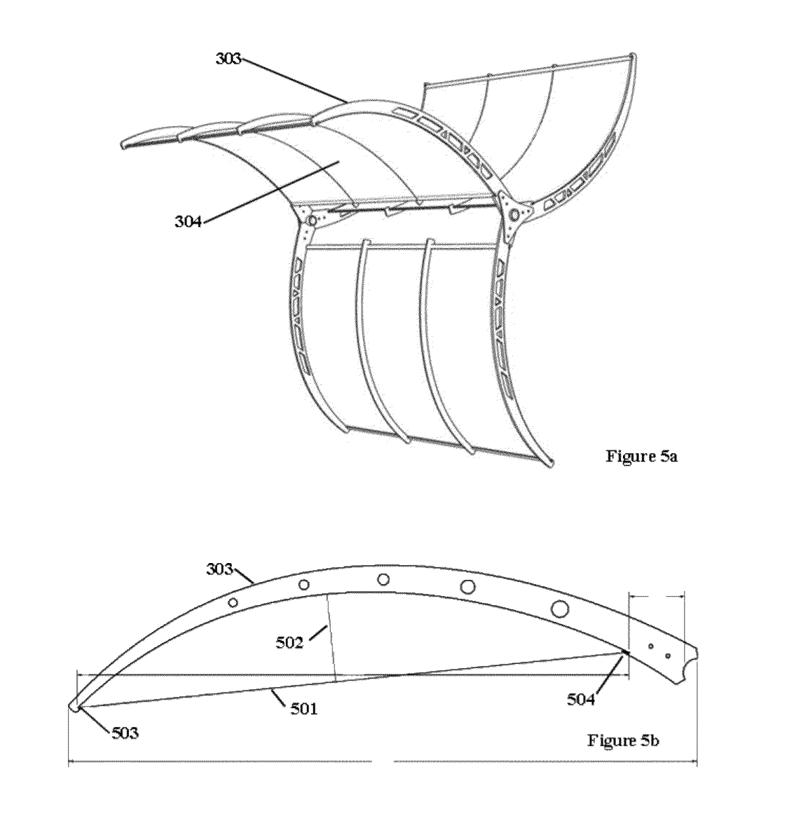

FIG. 5 illustrates blade mount 303. FIG. 5A illustrates blade mounts 303 within a blade set. Blade 304 and blade mount 303 can, in one embodiment, comprise of 6061 T-6 aluminum. Blades 304 can comprise of a sheet attached to blade mounts 303. As blade 304 is mounted, it will take on the curved shape of blade mounts 303. FIG. 5B illustrates blade mount curvature. The curvature of blade mount 303 affects the efficiency of turbine system 103. Measurement of curvature can be by the ratio a linear blade length 501 and a curve depth 502. For purposes of this disclosure, linear blade length 501 is measured as a straight line from a top blade grip 503 to a bottom blade grip 504, and curve depth 502 is the deepest point of blade mount 303 curvature, measured perpendicularly from a line along linear blade length 501. In one embodiment, curve depth to linear blade length ratio can be between 15 to 99 and 17 to 99. In one embodiment, curve depth to linear blade length ratio can be 16 to 99. In such embodiment, a blade with an eight-inch curve depth would have a 49.5-inch linear blade length. These particular curvatures have an anti-drag and a lift characteristic, which can increase efficiency. The surface of blade 303 can be smooth, in order to provide a quick exit of wind so that additional oncoming wind has the opportunity to hit blade 304 with minimal disturbance. To help maintain curvature, one or more battens can be placed along blade. Battens can be the same dimensions as blade mount 303, but do not connect to hub.

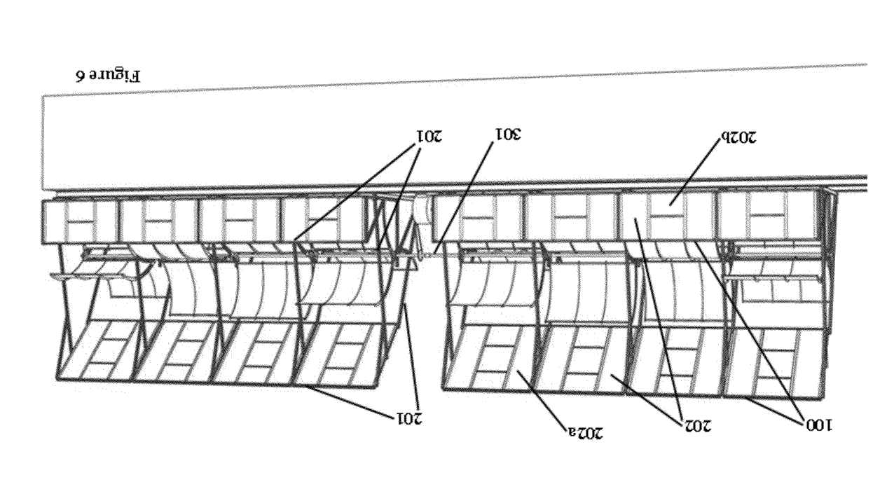

FIG. 6 illustrates a multiple blade set wind turbine shroud system. In one embodiment, shaft 301 can comprise a plurality of blade sets spaced along shaft 301. In such embodiment, upper shroud or lower shroud can be sized and positioned to cover multiple blade sets. In another embodiment, multiple separate upper shrouds 202a and lower shrouds 202b can be positioned to cover multiple blade sets. Frame 201 can be expanded to support multiple shrouds 200 or enlarged shrouds 201, or a plurality of frames 201 can be used.

Various changes in the details of the illustrated operational systems are possible without departing from the scope of the following claims. Some embodiments may combine the activities described herein as being separate steps. Similarly, one or more of the described steps may be omitted, depending upon the specific operational environment the system is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A shroud system comprising
a frame comprising a base and a substantially vertical support structure, said substantially vertical support structure having a top portion and a bottom portion, wherein said bottom portions connect to a base; and
an upper wind shroud connected to said top portion of said support structure, wherein said upper wind shroud is angled between thirty degrees and seventy-five degrees, further wherein a front portion of said wind shroud extends higher than a rear portion of said wind shroud.

2. The shroud system of claim 1 wherein said support structure comprises a front portion and a rear portion, wherein said front portion of said support structure connects to said front portion of shroud system, and said rear portion of said support structure connects to said rear portion of said shroud system.

3. The shroud system of claim 1 wherein said base comprises a plurality of horizontal beams.

4. The shroud system of claim 3 wherein said base comprises fasteners to connect to a structure.

5. The shroud system of claim 1 wherein said base comprises fasteners that attach to a structure.

6. The shroud system of claim 2 further comprising a lower wind shroud placed substantially vertically at a front portion of said base.

7. The shroud system of claim 6 wherein said lower wind shroud connects to said frame.

8. The shroud system of claim 6 wherein said lower wind shroud connects to said base.

9. The shroud system of claim 1 wherein said lower wind shroud comprises a 6061 T-6 aluminum sheet.

10. The shroud system of claim 9 wherein said frame comprises 6061 T-6 aluminum.

11. The shroud system of claim 6 wherein said lower wind shroud comprises a 6061 T-6 aluminum sheet.

12. The shroud system of claim 6 wherein said upper shroud is angled at forty-five degrees.

13. A shroud system comprising a frame comprising a base;
a lower wind shroud connected to said frame, wherein said lower wind shroud is angled between thirty and seventy-five degrees.

14. The shroud system of claim 13 comprising a substantially vertical support structure, said substantially vertical support structure having a top portion and a bottom portion, wherein said bottom portion connects to said base.

15. The shroud system of claim 14 wherein said lower wind shroud connects to said vertical support structure.

16. The shroud system of claim 13 wherein said lower wind shroud comprises a 6061 T-6 aluminum sheet.

17. The shroud system of claim 13 wherein said frame comprises 6061 T-6 aluminum.
